(19) United States
(12) Patent Application Publication
(10) Pub. No.: US 2023/0337756 A1
(43) Pub. Date: Oct. 26, 2023

(54) ELECTRIC HEATING GLOVE

(71) Applicant: SHENZHEN LINKWO TECHNOLOGY CO., LTD, Shenzhen (CN)

(72) Inventor: Wei LIU, Shenzhen (CN)

(73) Assignee: SHENZHEN LINKWO TECHNOLOGY CO., LTD, Shenzhen (CN)

(21) Appl. No.: 18/133,095

(22) Filed: Apr. 11, 2023

(30) Foreign Application Priority Data
Apr. 22, 2022 (CN) 202220949225.1

(51) Int. Cl. A41D 13/005; H05B 1/02; A41D 19/00; A41D 19/01

(52) U.S. Cl. CPC A41D 13/0051; H05B 1/0272; A41D 19/0024; A41D 19/01

(57) ABSTRACT

Provided are an electric heating glove. The electric heating glove includes a glove body, a heat generating layer, a power supply device and a switch component. A length of a finger heating portion of the heat generating layer may be slightly greater than a length of a finger portion of the glove body, the finger heating portion is provided with a hollow portion at a fingertip of the finger portion, a portion of the finger heating portion longer than the finger portion is bent from the hollow portion to a finger pulp of the finger portion, so that both a finger back portion of the finger portion and the finger pulp of the finger portion can be wrapped by the heat generating layer.

### CROSS REFERENCE TO RELATED APPLICATIONS

This application claims priority to Chinese Patent Application No. 202220949225.1 filed Apr. 22, 2022, the disclosure of which is incorporated herein by reference in its entirety.

### TECHNICAL FIELD

The present disclosure relates to the field of thermal insulation devices and, in particular, to an electric heating glove.

### BACKGROUND

Extreme cold weather easily appears in winter in high latitude regions, the temperature is relatively lower, and thus people usually wear heating gloves so as to avoid the hand from being easily frozen and injured during outdoor operations or outdoor sports;

An existing electric heating glove generally adopts a technical scheme that a layer of electric heating wire is disposed inside the glove, and a battery for supplying power to the electric heating wire is disposed at an opening of the glove. Though such glove can provide a certain heat preservation effect, the heat preservation effect on the tips of fingers is not ideal.

### SUMMARY

The present disclosure provides an electric heating glove, which is intended to solve an issue typically found in the related art, that is, a layer of electric heating wire is disposed inside the glove, and a battery for supplying power to the electric heating wire is disposed at an opening of the glove, resulting in that though the glove can provide a certain heat preservation effect, the heat preservation effect on the tips of fingers is not ideal.

In order to solve the above-described technical issue, the present disclosure provides an electric heating glove. The electric heating glove includes a glove body, a heat generating layer, a power supply device and a switch component. The heat generating layer is disposed within the glove body, the heat generating layer includes a palm heating portion and a finger heating portion, a length of the finger heating portion is greater than a length of a finger portion of the glove body, the finger heating portion is provided with a hollow portion at a fingertip of the finger portion, a portion of the finger heating portion longer than the finger portion is bent from the hollow portion to a finger pulp of the finger portion, so that both a finger back portion of the finger portion and the finger pulp of the finger portion can be wrapped by the heat generating layer. The power supply device is disposed within the glove body, the power supply device is connected to a first end of the switch component, and a second end of the switch component is connected to the heat generating layer.

In an embodiment, the electric heating glove further includes a locking structure. The locking structure includes a locking strap and a locking stop structure. The locking strap is disposed on the glove body, and the locking stop structure is disposed on the locking strap for adjusting a tightness of the locking strap.

In an embodiment, an outer layer of the finger portion of the glove body is provided with a magnetic layer.

In an embodiment, the glove body is internally provided with a receiving cavity for receiving the power supply device, and a zipper is disposed at an opening of the receiving cavity.

In an embodiment, the power supply device includes a shell, a battery, a charging and discharging pole piece, and a battery interface. The shell is internally provided with a fitting cavity, the battery is mounted within the fitting cavity; a first end of the charging and discharging pole piece is electrically connected to the battery, a second end of the charging and discharging pole piece is connected to the battery interface via an elastic connection member, the battery interface is connected to a first end of the switch component, and a second end of the switch component is electrically connected to the heat generating layer.

In an embodiment, the switch component includes a switch interface, a control switch, and a heat generating layer interface. A first end of the switch interface is connected to the battery interface, a second end of the switch interface is connected to a first end of the control switch, a second end of the control switch is connected to the heat generating layer interface, and the heat generating layer interface is electrically connected to the heat generating layer.

In an embodiment, the control switch is an adjustable switch which can adjust heating power of the heat generating layer.

In an embodiment, the control switch further includes a display light, and the display light is configured to adjust a display state based on adjustment of heating power of the heat generating layer by the control switch.

In an embodiment, the battery interface includes a protection housing and a male interface. An end of the protection housing in contact with the switch interface is provided with a groove, the male interface is disposed within the groove, the switch interface includes a female interface, an outer side of the female interface is provided with a covering layer, in a case where the battery interface is connected to the switch interface, the male interface interfaces with the female interface, the covering layer is inserted into the groove, and the covering layer is wrapped by the protection housing.

In an embodiment, the finger portion includes a mitten structure and/or a five-finger structure.

### BRIEF DESCRIPTION OF DRAWINGS

FIG. 1 is a structure view of an electric heating glove with a five-finger structure according to an embodiment of the present disclosure;

FIG. 2 is a structure view of a heat generating layer with a five-finger structure according to an embodiment of the present disclosure;

FIG. 3 is a structure view of a heat generating layer with a mitten structure according to an embodiment of the present disclosure;

FIG. 4 is an exploded view of a power supply device according to an embodiment of the present disclosure;

FIG. 5 is a structure view of a battery interface according to an embodiment of the present disclosure;

FIG. 6 is a structure view of a switch component according to an embodiment of the present disclosure;

FIG. 7 is a structure view of a switch interface according to an embodiment of the present disclosure; and

FIG. 8 is a structure view of an electric heating glove with a mitten structure according to an embodiment of the present disclosure.

The realizations of objectives, functional features and advantages of the present disclosure will be further described in connection with the embodiments, with reference to the accompanying drawings.

### DETAILED DESCRIPTION

It should be understood that specific embodiments described herein are merely illustrative of the present disclosure and are not intended to limit the present disclosure.

Technical schemes in embodiments of the present disclosure will be described clearly and completely below in conjunction with the drawings in the embodiments of the present disclosure. Apparently, the described embodiments are merely part of the embodiments of the present disclosure, rather than all of the embodiments of the present disclosure. All other embodiments obtained by those of ordinary skill in the art based on the embodiments of the present disclosure without requiring creative efforts shall all fall within the scope of protection of the present disclosure.

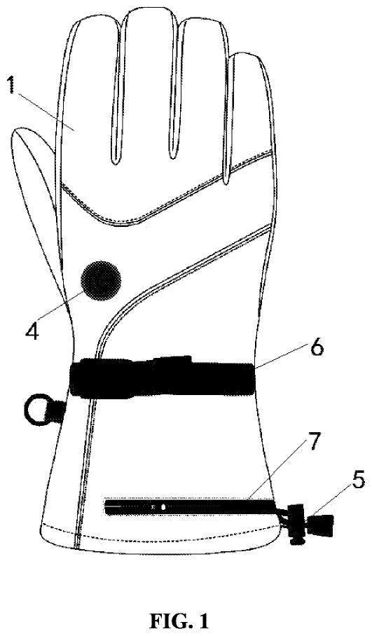

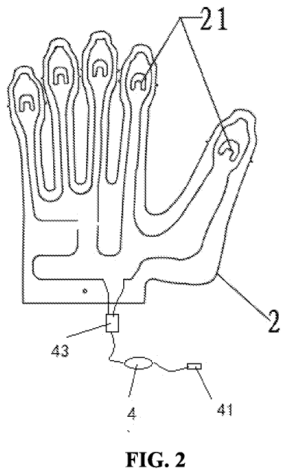

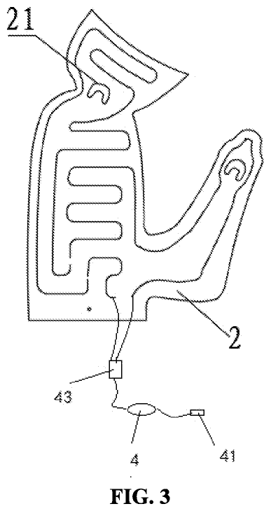

Referring to FIGS. 1 to 6, the present disclosure provides an electric heating glove. The electric heating glove includes a glove body 1, a heat generating layer 2, a power supply device 3 and a switch component 4. The heat generating layer 2 is disposed within the glove body 1, the heat generating layer 2 includes a palm heating portion and a finger heating portion, a length of the finger heating portion is greater than a length of a finger portion of the glove body 1, the finger heating portion is provided with a hollow portion 21 at a fingertip of the finger portion, a portion of the finger heating portion longer than the finger portion is bent from the hollow portion 21 to a finger pulp of the finger portion, so that both a finger back portion of the finger portion and the finger pulp of the finger portion can be wrapped by the heat generating layer 2. The power supply device 3 is disposed within the glove body 1, the power supply device 3 is connected to a first end of the switch component 4, and a second end of the switch component 4 is connected to the heat generating layer 2.

As described above, the electric heating glove provided in this embodiment includes the glove body 1, the heat generating layer 2, the power supply device 3 and the switch component 4. The heat generating layer 2 is disposed within the glove body 1, the glove body 1 may be a mitten structure or a five-finger structure, further, a multi-layer structure may be provided within the glove body 1, such as an outer layer cloth for protecting an inner layer material, a waterproof layer for water resistance, a rechecking heat preservation layer for heat insulation and heat preservation, a sponge layer, and a heat generating layer 2 for heating the glove body 1. Heating wires are evenly distributed in the heat generating layer, the heating wire may be a composite fiber heating line with a bending resistance, the heating wire is connected to the power supply device 3 through the switch component 4, a battery 32 is disposed within the power supply device 3 for supplying power to the heating wire, the switch component 4 is configured to control a state of connection of an electric circuit between the heating wire and the power supply device 3, that is, a user can adjust and control whether the heat generating layer 2 needs to be heated by means of the switch component 4. The heat generating layer 2 includes the palm heating portion and the finger heating portion, where the length of the finger heating portion is slightly greater than the length of the finger portion of the glove body 1, the finger heating portion is provided with the hollow portion 21 at the fingertip of the finger portion, the finger heating portion should not be too long, it should be desirable that after the hollow portion 21 is bent to the finger pulp of the finger portion, the portion of the finger heating portion longer than the finger portion is bent to just cover a finger pulp of a corresponding finger portion, and in this way, when the user uses the electric heating glove, not only the back of the hand and the back of the finger can be heated, but also the fingertip and a finger pulp portion, which are more sensitive to coldness, are wrapped by the heat generating layer, thereby having the better heat preservation effect.

Referring to FIG. 1 or 8, in an embodiment, the electric heating glove further includes a locking structure 5. The locking structure 5 includes a locking strap and a locking stop structure. The locking strap is disposed on the glove body 1, and the locking stop structure is disposed on the locking strap for adjusting a tightness of the locking strap.

As described above, the electric heating glove is further provided with the locking structure 5 which may adjust the fitting degree of the glove body 1 and the wrist of the user. The locking structure 5 includes the locking strap and the locking stop structure. A locking layer for receiving the locking strap is disposed on the glove body 1, the locking layer may be disposed within the glove body 1, or disposed outside the glove body 1. The glove body 1 is connected to the locking layer to form a locking channel surrounding the glove body 1, a body of the locking strap is disposed in the locking channel, two ends of the locking strap extend out of the locking channel and into the locking stop structure, the locking stop structure is internally provided with a spring, and the tightness of the locking strap in the locking channel may be adjusted through pressing a button on an end of the locking stop structure.

Referring to FIG. 1 or 8, in an embodiment, the electric heating glove further includes a tension structure 6. The tension structure 6 includes a tension cord and a locking clasp, and is configured to adjust the fitting degree of the glove body 1 and the wrist of the user.

As described above, a number of locking rings may be disposed outside the glove body 1, the tension cord is threaded through the locking rings (such as, belt buckles in pants), and adjusts the fitting degree of the glove body 1 and the wrist of the user by means of a tension structure 6, which is similar to a bunching buckle in a saddle bag harness.

In an embodiment, an outer layer of the finger portion of the glove body 1 is provided with a magnetic layer.

As described above, an outermost layer of the finger pulp of the finger portion of the glove body 1 is provided with the magnetic layer, the magnetic layer may be disposed at a finger pulp portion of an index finger of the glove body 1, or may be disposed at a finger pulp portion of each finger of the glove body 1, which is not specifically limited here. The glove body 1 is provided with the magnetic layer, so that a screen of a mobile phone may be operated conveniently, and the user may operate the mobile phone without taking off the glove when the glove is worn.

Referring to FIG. 1 or 8, in an embodiment, the glove body 1 is internally provided with a receiving cavity for receiving the power supply device 3, and a zipper 7 is disposed at an opening of the receiving cavity so as to prevent the power supply device 3 from falling out of the receiving cavity.

As described above, the glove body 1 is internally provided with the receiving cavity for receiving the power supply device 3, the receiving cavity is provided with a through hole for connecting the wires of the switch component 4, and the zipper 7 is disposed at the opening of the receiving cavity, in a preferred embodiment, the zipper 7 is a waterproof zipper 7, the waterproof zipper 7 may prevent water from entering the receiving cavity in rainy and snowy weather to cause the short circuit of the power supply device 3, and thus better protect the normal use of the power supply device 3 in severe weather.

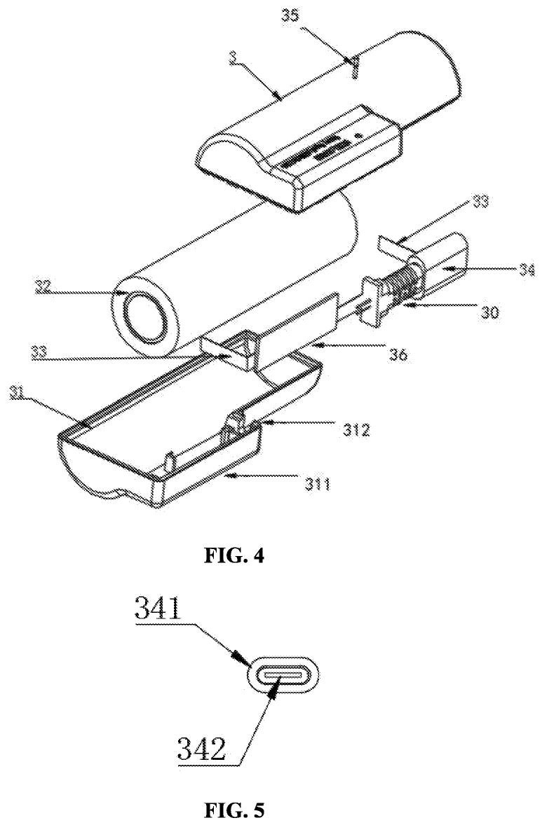

Referring to FIG. 4, in an embodiment, the power supply device 3 includes a shell 31, a battery 32, a charging and discharging pole piece 33, and a battery interface 34. The shell 31 is internally provided with a fitting cavity, the battery 32 is mounted within the fitting cavity; a first end of the charging and discharging pole piece 33 is electrically connected to the battery 32, a second end of the charging and discharging pole piece 33 is connected to the battery interface 34 via an elastic connection member 30, the battery interface 34 is connected to a first end of the switch component 4, and a second end of the switch component 4 is electrically connected to the heat generating layer 2.

As described above, the power supply device 3 in an embodiment of the present disclosure includes the shell 31, the battery 32, the charging and discharging pole piece 33, and the battery interface 34. The shell 31 may be formed by integral thermoplastic molding, or may be formed by assembling two detachable upper and lower shells. The shell 31 may have different shapes according to specifications of the battery 32, and may be cylindrical, rectangular or the like, which is not specifically limited in this embodiment. The shell 31 is hollow, a fitting cavity for fitting the battery 32 is formed inside the shell 31, a shape of the fitting cavity may be set according to the specifications of the battery 32, which is not specifically limited in this embodiment. The fitting cavity is internally provided with the charging and discharging pole piece 33 connected to the battery 32, the charging and discharging pole piece 33 includes a positive charging and discharging pole piece and a negative charging and discharging pole piece, two ends of the positive charging and discharging pole piece are electrically connected to a positive electrode of the battery 32 and a positive electrode of the battery interface 34, respectively, two ends of the negative charging and discharging pole piece are electrically connected to a negative electrode of the battery 32 and a negative electrode of the battery interface 34, respectively. The elastic connection member 30 acts as a carrier for connecting the charging and discharging pole piece 33 and the battery interface 34, and has stretch elasticity, the battery interface 34 is movable relative to the shell 31 within a certain range, that is, the battery interface 34 may be bent outward in a direction facing away from a side wall of the battery 32, in this way, it is convenient to connect the battery interface 34 with a heating wire interface in the glove, moreover, when the battery 32 is connected to the heating wire interface in the glove, since the elastic connection member 30 has better elasticity, even if the power supply device 3 wobbles inside the receiving cavity because the user does not stop moving, the battery interface 34 and the heating wire interface do not easily fall off under the buffering of the elastic connection member 30 to cause the power failure, and the battery interface 34 is connected to a switch interface 41 of the switch component 4, and the switch component 4 is also electrically connected to the heat generating layer 2.

In an embodiment, the charging and discharging pole piece 33 is disposed within the fitting cavity formed in the shell 31, the charging and discharging pole piece 33 includes a positive charging and discharging pole piece and a negative charging and discharging pole piece, a first end of the positive charging and discharging pole piece is connected to a positive electrode of the battery 32, a second end of the positive charging and discharging pole piece is connected to a positive electrode of the battery interface 34 via the elastic connection member 30, a first end of the negative charging and discharging pole piece is connected to a negative electrode of the battery 32, and a second end of the negative charging and discharging pole piece is connected to a negative electrode of the battery interface 34 via the elastic connection member 30.

As described above, the charging and discharging pole piece 33 is disposed within the fitting cavity, and the charging and discharging pole piece 33 includes the positive charging and discharging pole piece and the negative charging and discharging pole piece, the two ends of the positive charging and discharging pole piece are electrically connected to the positive electrode of the battery 32 and the positive electrode of the battery interface 34, respectively, the two ends of the negative charging and discharging pole piece are electrically connected to the negative electrode of the battery 32 and the negative electrode of the battery interface 34, respectively. A portion of the positive charging and discharging pole piece that is connected to the positive electrode of the battery interface 34, and a portion of the negative charging and discharging pole piece that is connected to the negative electrode of the battery interface 34 may be adhered to a surface of the elastic connection member 30, in a preferred embodiment, the portion of the positive charging and discharging pole piece that is connected to the positive electrode of the battery interface 34, and the portion of the negative charging and discharging pole piece that is connected to the negative electrode of the battery interface 34 are disposed inside the elastic connection member 30, that is, the elastic connection member 30 may wrap around the portion of the charging and discharging pole piece 33 that is connected to the battery interface 34, so as to avoid the pole pieces from being exposed and stuck with rainwater and the like.

In an embodiment, an end of the shell 31 facing away from the battery interface 34 extends outwardly to form a fitting slot 311, the fitting slot 311 is internally provided with an engagement portion 312, a first end of the elastic connection member 30 is engaged inside the fitting slot 311, a second end of the elastic connection member 30 is connected to the battery interface 34 after protruding from the fitting slot 311, the elastic connection member 30 is internally provided with a positive electrode connection member and a negative electrode connection member, a first end of a positive electrode charging pole piece is connected to a positive electrode of the battery 32, a second end of the positive electrode charging pole piece is connected to a first end of the positive electrode connection member, a second end of the positive electrode connection member is connected to a positive electrode of the battery interface 34, a first end of a negative electrode charging pole piece is connected to a negative electrode of the battery 32, a second end of the negative electrode charging pole piece is connected to a first end of the negative electrode connection member, and a second end of the negative electrode connection member is connected to a negative electrode of the battery interface 34.

As described above, the charging and discharging pole piece 33 may not be directly connected to the battery interface 34, but the positive electrode connection member and the negative electrode connection member are disposed in the elastic connection member 30, and the positive charging and discharging pole piece is connected to the positive electrode of the battery interface 34 through the positive electrode connection member, the negative charging and discharging pole piece is connected to the negative electrode of the battery interface 34 through the negative electrode connection member, the positive electrode connection member and the negative electrode connection member may be wires or metal elastic sheets with conductive properties and elastic contraction properties. Similarly, the positive electrode connection member and the negative electrode connection member may be disposed to adhere to the surface of the elastic connection member 30, and may also be disposed inside and wrapped by the elastic connection member 30, the end of the shell 31 facing away from the battery interface 34 extends outwards to form the fitting slot 311, an end of the fitting slot 311 facing the battery interface 34 is provided with an engagement portion 312, a portion of the elastic connection member 30 is engaged in the engagement portion 312, and the other portion of the elastic connection member 30 extends out of the fitting slot 311 and is connected to the battery interface 34.

In an embodiment, the elastic connection member 30 includes a fixing portion and an elastic moving portion, the fixing portion is engaged within the engagement portion 312, a first end of the elastic moving portion is connected to the fixing portion, and a second end of the elastic moving portion protrudes out of the fitting slot 311 and then is connected to the battery interface 34.

As described above, the elastic connection member 30 includes the fixing portion and the elastic moving portion, a rigid rigidity of the fixing portion is stronger than a rigid rigidity of the elastic moving portion to ensure that the fixing portion may be well engaged in the engagement portion 312, and the elastic moving portion extends out of the shell 31 from the fixing portion in a length direction of the battery 32 and then is connected to the battery interface 34.

In an embodiment, the power supply device 3 further includes a protection plate 36, a protection circuit is disposed in the protection plate 36, the fitting slot 311 is internally provided with an engagement component, the protection plate 36 is disposed on the engagement component, a first end of the positive charging and discharging pole piece is connected to a positive electrode of the battery 32, a second end of the positive charging and discharging pole piece is connected to a charging output discharging input end of the protection circuit, and/or a first end of a negative charging and discharge pole piece is connected to a negative electrode of the battery 32, and a second end of the negative charging and discharge pole piece is connected to a charging output discharging input end of the protection circuit, and a charging input discharging output end of the protection circuit is electrically connected to the battery interface 34.

As described above, the fitting slot 311 is internally provided with the engagement component, the protection plate 36 is disposed on the engagement component, and the protection circuit is disposed on the protection plate 36. The positive charging and discharging pole piece and/or the negative charging and discharging pole piece are connected to the charging output discharging input end of the protection circuit, the charging input discharging output end of the protection circuit is electrically connected to the battery interface 34, the protection circuit has a charging and discharging protection effect on the battery 32, that is, the protection circuit may prevent overcharging when the battery 32 is charged and prevent overdischarging when the battery 32 is discharged. As one preference, an indicator light such as a color-changeable LED light is disposed in the protection circuit for displaying a charging and discharging state of the battery 32, when the battery 32 is charged, the indicator light displays a red color, when the battery 32 is discharged, the indicator light displays a green color, further, the amount of charge of the battery 32 may be roughly judged by the shade of the color, and in use, a working state of the battery 32 may be known by observing the color of the indicator light through a light guide post 35.

In an embodiment, a height of the fitting slot 311 is slightly greater than a thickness of the battery interface 34 and the elastic connection member 30.

As described above, when the end of the shell 31 facing away from the battery interface 34 extends outwards to form the fitting slot 311, a distance at which it extends outwards is slightly greater than the thickness of the battery interface 34 and the elastic connection member 30, that is, the height of the fitting slot 311 is slightly greater than the thickness of the battery interface 34 and the elastic connection member 30, therefore, the battery interface 34 and the elastic connection member 30 do not rise above the fitting slot 311, so that an overall construction of the battery interface 34 and the elastic connection member 30 with the housing is more compact and more convenient to package.

In an embodiment, the positive electrode connection member and the negative electrode connection member include a wire and/or a metal elastic sheet.

In an embodiment, the battery interface 34 is a type-C interface.

As described above, the battery interface 34 is the type-C interface, the type-C interface may enable a connection with the heating wire interface at an end of the glove to be firmer, but the type-C interface is not limited to the type-C interface, and may also be other common electronic device interfaces such as a USB interface.

In an embodiment, the shell 31 is internally provided with a light guide post 35 for displaying the charging and discharging state of the battery 32.

As described above, a through hole is disposed in an upper shell or a lower shell of the shell 31 and the light guide post 35 is provided in the through hole for displaying the charging and discharging states of the battery 32.

In an embodiment, the elastic connection member 30 is made of a thermoplastic elastomeric material and is more resistant to bending and wear, which facilitates extending the service life of the power supply device 3.

As described above, the elastic connection member 30 is made of the thermoplastic elastomeric material and has good bending resistance and wear resistance.

In an embodiment, the shell 31 includes an upper shell and a lower shell, and the upper shell is removably connected to the lower shell.

In an embodiment, the battery 32 includes, but is not limited to, a lithium battery 32, a polymer lithium battery 32, and types of the battery 32 include, but are not limited to, 21700 cells, 595885 cells, 18650 cells.

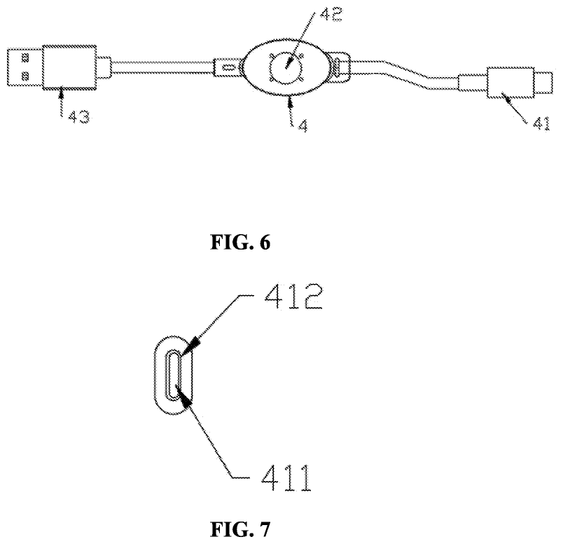

Referring to FIG. 6, in an embodiment, the switch component 4 includes a switch interface 41, a control switch 42, and a heat generating layer interface 43. A first end of the switch interface 41 is connected to the battery interface 34, a second end of the switch interface 41 is connected to a first end of the control switch 42, a second end of the control switch 42 is connected to the heat generating layer interface 43, and the heat generating layer interface 43 is electrically connected to the heat generating layer 2.

In an embodiment, the control switch 42 is an adjustable switch which may adjust heating power of the heat generating layer 2.

As described above, the switch component 4 includes the switch interface 41, the control switch 42 and the heat generating layer interface 43. The switch interface 41 is connected to the battery interface 34 of the power supply device 3, the control switch 42 is disposed between the switch interface 41 and the heat generating layer interface 43 for controlling the connection and disconnection between the power supply device 3 and the heat generating layer 2. The control switch 42 is the adjustable switch which may adjust the heating power of the heat generating layer 2, the control switch 42 may be a push button switch, that is, it is in a low temperature heating mode when pressing one time, it is in a medium temperature heating mode when pressing two times, it is in a high temperature heating mode when pressing three times, and it is turned off heating when pressing two times in tandem, etc., and a specific adjustment mode may be set according to the actual use condition, the control switch 42 may be a knob switch, and the heating power of the heat generating layer 2 may be adjusted linearly according to a rotation angle of the knob switch in order to satisfy people with different demands on the temperature of the hands.

In an embodiment, the control switch 42 further includes a display light, and the display light is configured to adjust a display state based on the adjustment of heating power of the heat generating layer 2 by the control switch 42.

As described above, the control switch 42 further includes the display light, and the display light may adjust the display state based on the adjustment of the heating power of the heat generating layer 2 by the control switch 42. For example, a blue color is displayed in the low temperature heating mode, a yellow color is displayed in the medium temperature heating mode, a red color is displayed in the high temperature heating mode, or a same color in different shades is displayed based on the heating power of the heat generating layer 2.

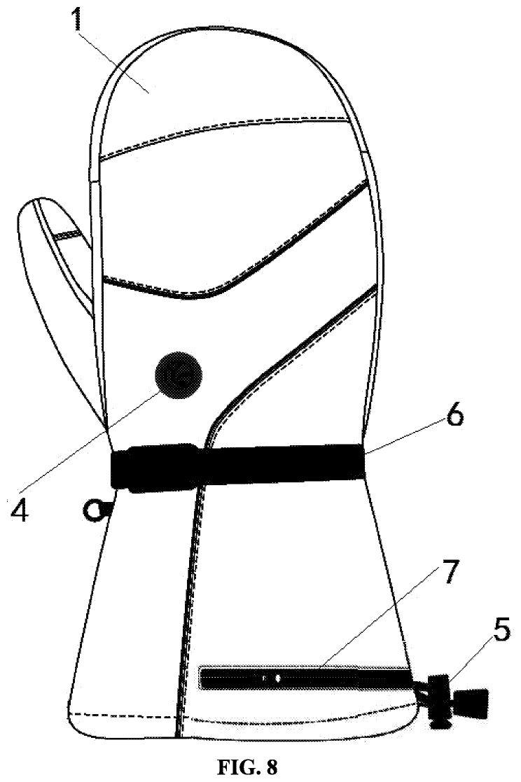

Referring to FIGS. 5 and 7, in an embodiment, the battery interface 34 includes a protection housing 341 and a male interface 342. An end of the protection housing 341 in contact with the switch interface 41 is provided with a groove, the male interface 342 is disposed within the groove, the switch interface 41 includes a female interface 411, an outer side of the female interface 41 is provided with a covering layer 412, when the battery interface 34 is connected to the switch interface 41, the male interface 342 interfaces with the female interface 411, the covering layer 412 is inserted into the groove, and the covering layer 412 is wrapped by the protection housing 341.

As described above, the battery interface 34 includes the protection housing 341 and the male interface 342. The end of the protection housing 341 in contact with the switch interface 41 is provided with the groove, an end of the male interface 342 in contact with the switch interface 41 protrudes from the protection housing 341 into the groove, an other end of the male interface 342 is connected to the battery 32 via the elastic connection member 30 and the charging and discharging pole piece 33. The switch interface 41 includes the female interface 411, the outer side of the female interface 411 is provided with the covering layer 412, when the battery interface 34 is connected to the switch interface 41, the male interface 342 is connected to the female interface 411, and the covering layer 412 of the male interface 342 is tightly wrapped by the protection housing 341, which may be less likely to loosen to cause the power failure after the two are connected, and meanwhile, the tight fit of the protection housing 341 and the covering layer 412 also has some waterproofing effect.

In an embodiment, the finger portion includes a mitten structure and/or a five-finger structure.

As described above, the finger portion may be a mitten glove or a five-finger glove, except that the finger portion is divided into the mitten structure and the five-finger structure, the connecting relationship, the shape specification and the like of other structures in the present disclosure are the same.

It should be noted that, all directional indications (such as, up, down, left, right, front, back) in the embodiments of the present disclosure are merely intended to explain the relative positional relationship, motion conditions, etc. between components in a certain specific gesture (as shown in the drawings). If the specific gesture changes, the directional indication changes accordingly, and the connection may be a direct connection or an indirect connection.

In addition, descriptions such as referring to “first”, “second”, etc. in the present disclosure are used only for the purpose of description and are not to be construed as indicating or implying relative importance thereof or implicitly indicating a number of indicated technical features. Thus, features defined as “first” and “second” may explicitly or implicitly include at least one of the features. In addition, technical schemes between the embodiments may be combined with each other, but they must be based on being able to be implemented by those of ordinary skill in the art, and when combinations of the technical schemes are contradictory to each other or cannot be achieved, the combinations of such technical schemes should be considered to be absent, and are not within the scope of protection of the present disclosure.

In the above description, the preferred embodiments of the present disclosure are merely described, which should not be considered as limitations of the patent scope of the present disclosure, and all equivalent structures or equivalent process transformations made by using the specification and the drawings of the present disclosure are directly or indirectly applied to other related technical fields, which are included within the scope of patent protection of the present disclosure.

What is claimed is:

1. An electric heating glove, comprising a glove body, a heat generating layer, a power supply device and a switch component, wherein,
the heat generating layer is disposed within the glove body, the heat generating layer comprises a palm heating portion and a finger heating portion, wherein a length of the finger heating portion is greater than a length of a finger portion of the glove body, the finger heating portion is provided with a hollow portion at a fingertip of the finger portion, and a portion of the finger heating portion longer than the finger portion is bent from the hollow portion to a finger pulp of the finger portion, enabling both a finger back portion of the finger portion and the finger pulp of the finger portion to be wrapped by the heat generating layer; and
the power supply device is disposed within the glove body, the power supply device is connected to a first end of the switch component, and a second end of the switch component is connected to the heat generating layer.

2. The electric heating glove of claim 1, further comprising a locking structure, wherein the locking structure comprises a locking strap and a locking stop structure, wherein the locking strap is disposed on the glove body, and the locking stop structure is disposed on the locking strap for adjusting a tightness of the locking strap.

3. The electric heating glove of claim 1, wherein an outer layer of the finger portion of the glove body is provided with a magnetic layer.

4. The electric heating glove of claim 1, wherein the glove body is internally provided with a receiving cavity for receiving the power supply device, and a zipper is disposed at an opening of the receiving cavity.

5. The electric heating glove of claim 1, wherein the power supply device comprises a shell, a battery, a charging and discharging pole piece, and a battery interface, wherein the shell is internally provided with a fitting cavity, the battery is mounted within the fitting cavity; a first end of the charging and discharging pole piece is electrically connected to the battery, a second end of the charging and discharging pole piece is connected to the battery interface via an elastic connection member, the battery interface is connected to a first end of the switch component, and a second end of the switch component is electrically connected to the heat generating layer.

6. The electric heating glove of claim 5, wherein the switch component comprises a switch interface, a control switch, and a heat generating layer interface, wherein a first end of the switch interface is connected to the battery interface, a second end of the switch interface is connected to a first end of the control switch, a second end of the control switch is connected to the heat generating layer interface, and the heat generating layer interface is electrically connected to the heat generating layer.

7. The electric heating glove of claim 6, wherein the control switch is an adjustable switch which can adjust heating power of the heat generating layer.

8. The electric heating glove of claim 6, wherein the control switch further comprises a display light, and the display light is configured to adjust a display state based on adjustment of heating power of the heat generating layer by the control switch.

9. The electric heating glove of claim 6, wherein the battery interface comprises a protection housing and a male interface, wherein an end of the protection housing in contact with the switch interface is provided with a groove, the male interface is disposed within the groove, the switch interface comprises a female interface, and an outer side of the female interface is provided with a covering layer; wherein in a case where the battery interface is connected to the switch interface, the male interface interfaces with the female interface, the covering layer is inserted into the groove, and the covering layer is wrapped by the protection housing.

10. The electric heating glove of claim 1, wherein the finger portion comprises a mitten structure or a five-finger structure.
